(19) United States
(12) Patent Application Publication
(10) Pub. No.: US 2012/0306848 A1
(43) Pub. Date: Dec. 6, 2012

(54) DIGITAL EYESIGHT MEASURING APPARATUS

(75) Inventors: Chang Hun Lee, Gyeonggi-Do (KR); Sang Uk Kim, Seoul (KR)

(73) Assignee: DOPTE CO., LTD, Gyeonggi-do (KR)

(21) Appl. No.: 13/575,658

(22) PCT Filed: Jul. 22, 2010
(86) PCT No.: PCT/KR2010/004801

§ 371 Date: Jul. 31, 2012

(30) Foreign Application Priority Data
Jan. 28, 2010 (KR) 10-2010-0007936

(51) Int. Cl. G06T 1/00

(52) U.S. Cl. 345/418

(57) ABSTRACT

Disclosed is a digital eyesight device, which comprises an ASIC (Application Specific Integrated Circuit) which includes a data storing part which stores a graphic data on an eyesight measurement table, an internal memory part which retrieves a graphic data from the data storing part; an embedded processor which has an internal processor part processing a graphic data, an external graphic processor which converts a 1-channel type graphic data processed by the embedded processor into a 2-channel type graphic data, a first bus which is connected between the embedded processor and the external graphic processor and is connected with the embedded processor in a signal transmission way, and a second bus which is electrically connected with the external graphic processor, said ASIC having an interface function interfacing the signal of the embedded processor to the external graphic processor and converting a 1-port 2-channel graphic data generated by the external graphic processor into a 2-port 2-channel graphic data; and a large size panel which receives a 2-port 2-channel type graphic data from the ASIC and displays it.

### TECHNICAL FIELD

The present invention relates to a digital eyesight measurement device and in particular to a digital eyesight measurement device which makes it possible to display an eyesight measurement table on a large size panel of above 17 inches with the aid of an inexpensive embedded processor which is generally used in a small size display device with a panel of smaller than 12 inches like a navigation device.

### BACKGROUND ART

An eyesight check is a necessary process during a health check or an ophthalmology check. A conventional eyesight measurement is conducted more than 3 meters away from a fixed type acryl panel with an eyesight measurement table formed thereon. The above mentioned eyesight measurement table is a fixed data type, so a testee might memorize the data, which results in an inaccurate eyesight check.

In order to overcome the above mentioned problems, a digital eyesight measurement device is developed, which stores various data on an eyesight measurement table.

The conventional digital eyesight measurement device is generally formed of an expensive computer body which processes a data on an eyesight measurement table and a monitor of above 17 inches which displays the data transferred from the computer main body.

The data formed on the eyesight measurement table is generally formed of a simple graphic data; however it seems that what a computer main body is used for the purpose of simply processing the above mentioned graphic data is like an excessive consumption, which consequently makes the conventional digital eyesight measurement device expensive.

There is an embedded CPU which seems to have an enough capacity for processing the graphic data of the digital eyesight measurement device. The embedded processor is generally built in a small size display device like a navigation device, which embedded processor is formed of one chip consisting of a graphic core provided therein for processing graphic data, an internal processor part, and an internal memory part.

In case of the above mentioned embedded processor, a graphic data of one channel type is transferred to a panel, and the panel displays a graphic data of one channel type. So, it is inevitably designed to transfer the data of a resolution of 800 pixels×600 pixels in one channel type, which is well applied to the panel of smaller than 12 inches.

In case of the conventional eyesight measurement device, the testee should be positioned more than 3 meters away from the eyesight measurement table for a precise eyesight measurement, for the sake of which a panel with at least bigger than 17 inches is needed so as to measure the eyesight from the above distance.

### SUMMARY OF INVENTION

Accordingly, it is an object of the present invention to provide a digital eyesight measurement device which makes it possible to display a high resolution graphic data on a panel with bigger than 17 inches with the aid of an inexpensive embedded processor.

It is another object of the present invention to provide a digital eyesight measurement device which makes it possible to display a graphic data on a panel bigger than 17 inches in such a way that an embedded processor and an external graphic processor, which have different bus types, are connected in a signal transmission way by adding one part, and a 1-port 2-chanel signal from the external graphic processor is converted into a 2-port 2-channl signal.

According to one aspect of the present invention, the digital eyesight measurement device comprises:

An ASIC (Application Specific Integrated Circuit) which includes:
a data storing part which stores a graphic data on an eyesight measurement table;

An internal memory part which retrieves a graphic data from the data storing part;
an embedded processor which has an internal processor part processing a graphic data;

An external graphic processor which converts a 1-channel type graphic data processed by the embedded processor into a 2-channel type graphic data;

A first bus which is connected between the embedded processor and the external graphic processor and is connected with the embedded processor in a signal transmission way; and
a second bus which is electrically connected with the external graphic processor, said ASIC having an interface function interfacing the signal of the embedded processor to the external graphic processor and converting a 1-port 2-channel graphic data generated by the external graphic processor into a 2-port 2-channel graphic data; and

A large size panel which receives a 2-port 2-channel type graphic data from the ASIC and displays it.

The digital eyesight measurement device according to the present invention can lower a manufacture unit cost by making use of an inexpensive universal type embedded processor.

In addition, the present invention makes it possible to efficiently transmit a high resolution signal to a large size panel of bigger than 17 inches by making use of an ASIC (Application Specific Integrated Circuit).

### BRIEF DESCRIPTION OF DRAWINGS

FIG. 1 is a view illustrating a construction of a digital eyesight measurement device according to an embodiment of the present invention.

### DETAILED DESCRIPTION OF THE INVENTION

The preferred embodiment of the present invention will be described herein below with reference to the accompanying drawing in details enough for an ordinary person skilled in the art to easily implement the present invention, not for the purpose of limiting the concept and scope of the present invention.

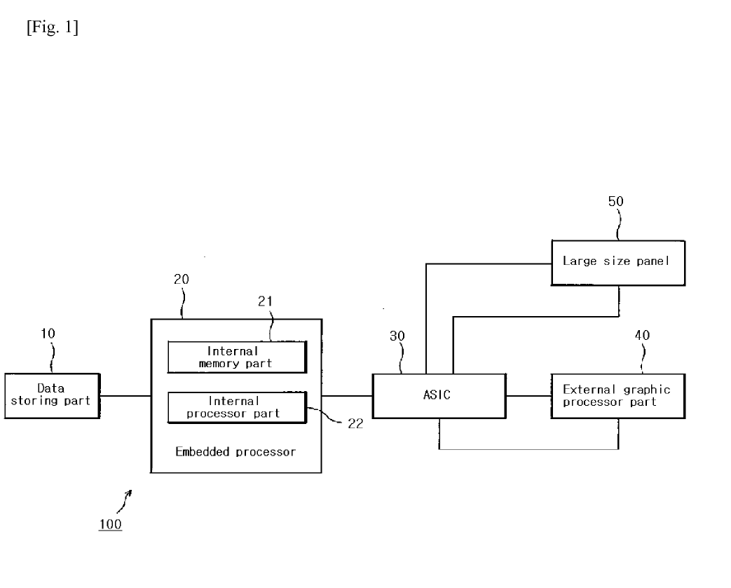

FIG. 1 is a view illustrating a construction of a digital eyesight measurement device according to an embodiment of the present invention.

As shown in FIG. 1, the digital eyesight measurement device 100 comprises an ASIC 30 (Application Specific Integrated Circuit) which includes a data storing part 10 which stores a graphic data on an eyesight measurement table; an internal memory part 21 which retrieves a graphic data from the data storing part 10; an embedded processor 20 which has an internal processor part 22 processing a graphic data; an external graphic processor 40 which converts a 1-channel type graphic data processed by the embedded processor 20 into a 2-channel type graphic data; a first bus which is connected between the embedded processor 20 and the external graphic processor 40 and is connected with the embedded processor 20 in a signal transmission way; and a second bus which is electrically connected with the external graphic processor, the ASIC having an interface function interfacing the signal of the embedded processor 20 to the external graphic processor 40 and converting a 1-port 2-channel graphic data generated by the external graphic processor 40 into a 2-port 2-channel graphic data; and a large size panel 50 which receives a 2-port 2-channel type graphic data from the ASIC 30 and displays it.

The digital eyesight measurement device 100 according to the present invention is directed to displaying, in a high resolution form, an eyesight measurement graphic data stored in a data storing part 10 on a large size panel 50 with bigger than 17 inches, thus measuring the eyesight of a testee. In addition, it is possible to display a small size eyesight measurement graphic data without causing problems in such a way to make use of an inexpensive embedded processor 20.

The eyesight measurement graphic data stored in the data storing part 10 is formed of a number, a symbol, a character, etc., which have different sizes and shapes for a precise measurement of a testee's eyesight. It is preferred that the above mentioned graphic data are arranged and displayed on the large size panel 50 in such a way that at least five data such as the symbols or characters having the same sizes are arranged in one row for the purpose of precisely measuring the eyesight of the testee. Since the eyesight measurement graphic data stored in the data storing part 10 are formed in a graphic shape, they generally have small sizes.

The embedded processor 20 is an inexpensive, integrated chip which is generally built in a small size display device such as a navigation device and is generally manufactured and sold in a universal type at a low cost. In the embedded processor 20, an internal memory part 21, an internal processor part 22 and a graphic core (not shown) are built in one chip for the purpose of processing a small size data. The internal memory part 21, the internal processor part 22 and the graphic core (not shown) are capable of data processing specific data and displaying them on a panel of smaller than 12 inches without adding an external device. In addition, the embedded processor 20 is a chip exclusively designed to display on a small size panel of smaller than 12 inches and is directed to processing a relatively small resolution data of 800 pixels×600 pixels and transmitting to a small size panel of smaller than 12 inches by way of one channel.

The digital eyesight measurement device 100 according to an embodiment of the present invention is characterized in that an eyesight measurement graphic data can be displayed in a high resolution on a large size panel 50 of bigger than 17 inches while reducing the manufacture cost by making use of an inexpensive embedded processor 20.

The method of directly connecting an embedded processor 20 to a large size panel 50 might be the best way; however such direct connection method has the following problems.

First of all, since the embedded processor 20 is designed to well fitting a small size panel, so it transmits data by way of one channel; however for the purpose of a high resolution display, the large size panel 50 of bigger than 17 inches receives a graphic data by way of two channels. So, it is needed to convert the graphic data of the one channel into the two channels.

Second of all, in case of the embedded processor 20, it is a part which is generally adapted to a small size display device such as a navigation device. It has a bus different from the external graphic processor 40 which is newly added in the process, so a direct engagement is impossible. So, it is needed to provide a certain construction having an interface function of connecting the embedded processor 20 and the external graphic processor 40 in a signal transfer way.

In order to overcome the above mentioned problems, the present embodiment of the present invention is directed to adding an ASIC 30 (Application Specific Integrated Circuit) between the embedded processor 20 and the external graphic processor 40. The ASIC 30 is referred to a non-memory semiconductor designed for the purpose of being used in an electronic and information communication product, which feature is different from a common integrated circuit.

The ASIC 30 has the following two functions.

First of all, there is an interface function of connecting the embedded processor 20 and the external graphic processor 40 in a signal transmission way. The embedded processor 20 is not manufactured for a connection with an external graphic processor 40 when it is first manufactured, so it has a different bus type. The first bus formed at the ASIC 30 can be connected with the bus of the embedded processor 20. In addition, the second bus formed at the ASIC 30 can be connected with the bus of the external graphic processor 40. Both the buses of the embedded processor 20 and the external graphic processor 40 cannot be directly connected since they are all PCI bus types, but the numbers of pins are different. The ASIC 30 according to the present embodiment of the present invention is basically manufactured for the purpose of interfaces, so it is possible to connect the embedded processor 20 and the external graphic processor 40 in a signal transmission way.

The second function of the ASIC 30 is to convert the 1-port 2-channel graphic data onto a 2-port 2-channel graphic data. As mentioned earlier, the large size pane 50 of bigger than 17 inches is manufactured to receive a graphic data in a 2-port 2-channel way. The external graphic processor 40 converts the graphic data of one channel type into the two channels; however the transmission from the external graphic processor 40 to the outside is conducted by way of a 1-port 2-channel method. So, it is needed to convert the 1-port 2-channel signal into a 2-port 2-channel type for the large size panel 50 to receive signals. The ASIC 30 of the present embodiment is directed to converting a 1-port 2-channel signal into a 2-port 2-channel signal type.

As mentioned earlier, the ASIC 30 is capable of interfacing various electronic chips by making use of its various functions depending on how the logic circuits are programmed. The ASIC 30 of the present embodiment is connected between the embedded processor 20 and the ASIC 30 for thereby interfacing the buses with different types to be connected with each other in a signal transmission way, and the 1-port 2-channel type signal can be converted into the 2-port 2-channel type signals. Consequently, the graphic data from the embedded processor 20 can be transmitted to the large size panel 50 in a high resolution without causing problems.

In the present embodiment, the large size panel 50 means a panel bigger than 17 inches, and it might be 19 inches, 22 inches, 24 inches, etc. The high resolution of the present embodiment means 1280 pixels×1024 pixels in a 17 inches panel, and 1280 pixels×1024 pixels in a 19 inches panel, 1680 pixels×1050 pixels in a 22 inches panel, and 1680 pixels×1050 pixels in a 24 inches panel.

The remaining constructions of the above mentioned digital eyesight measurement device 10 except for the large size panel 50 can be actually mounted on a printed circuit board and can be connected in a signal transmission way.

As described above, the digital eyesight measurement device 10 of the present embodiment contributes to lowering the manufacture cost by making use of the inexpensive universal type embedded processor 20. In addition, it is possible to reliably transmit the signal to the large size panel 50 of bigger than 17 inches by making use of the ASIC 30.

The embodiment of the present invention has been described so far; however it is just an embodiment, not limiting the scope of the claims of the present invention. It is obvious to an ordinary person skilled in the art that any modifications and additions belong to the scope of the present invention depending on equivalent principles.

According to one aspect of the present invention, the digital eyesight measurement device comprises:

An ASIC (Application Specific Integrated Circuit) which includes:
a data storing part which stores a graphic data on an eyesight measurement table;

An internal memory part which retrieves a graphic data from the data storing part;
an embedded processor which has an internal processor part processing a graphic data;

An external graphic processor which converts a 1-channel type graphic data processed by the embedded processor into a 2-channel type graphic data;

A first bus which is connected between the embedded processor and the external graphic processor and is connected with the embedded processor in a signal transmission way; and
a second bus which is electrically connected with the external graphic processor, said ASIC having an interface function interfacing the signal of the embedded processor to the external graphic processor and converting a 1-port 2-channel graphic data generated by the external graphic processor into a 2-port 2-channel graphic data; and

A large size panel which receives a 2-port 2-channel type graphic data from the ASIC and displays it.

The present invention makes it possible to enhance the precision during the eyesight measurement for the medical purpose, and an inexpensive digital eyesight device can be provided to a customer.

1. A digital eyesight measurement device, comprising:
an ASIC (Application Specific Integrated Circuit) which includes:
a data storing part which stores a graphic data on an eyesight measurement table;
an internal memory part which retrieves a graphic data from the data storing part;
an embedded processor which has an internal processor part processing a graphic data;
an external graphic processor which converts a 1-channel type graphic data processed by the embedded processor into a 2-channel type graphic data;
a first bus which is connected between the embedded processor and the external graphic processor and is connected with the embedded processor in a signal transmission way; and
a second bus which is electrically connected with the external graphic processor, said ASIC having an interface function interfacing the signal of the embedded processor to the external graphic processor and converting a 1-port 2-channel graphic data generated by the external graphic processor into a 2-port 2-channel graphic data; and
a large size panel which receives a 2-port 2-channel type graphic data from the ASIC and displays it.
